(19) United States
(12) Patent Application Publication
(10) Pub. No.: US 2024/0092673 A1
(43) Pub. Date: Mar. 21, 2024

(54) FURNACE CONTROL

(71) Applicant: SAINT-GOBAIN ISOVER, COURBEVOIE (FR)

(72) Inventors: Antoine GUILLET, PARIS (FR); Merwane MAIZA, NANCY (FR)

(21) Appl. No.: 18/262,123

(22) PCT Filed: Feb. 25, 2022
(86) PCT No.: PCT/FR2022/050347

§ 371 Date: Jul. 19, 2023

(30) Foreign Application Priority Data
Feb. 26, 2021 (FR) FR2101878

(51) Int. Cl. C03B 5/24; C03B 3/00; C03B 5/235

(52) U.S. Cl. CPC C03B 5/24; C03B 3/005; C03B 5/2356

(57) ABSTRACT

A method for controlling a plant for melting a raw-material composition, suitable for obtaining mineral wool, cullet, textile glass yarns and/or flat glass or container glassware, which includes a melting chamber suitable for melting the composition, wherein the composition includes at least one wet mixture of mineral wool and/or biomass, and the method includes controlling at least one physical variable that has an impact on the output of the melting chamber, the controlling being carried out as a function of the moisture content of the composition and/or of the wet mixture, as measured before introduction of the composition and/or of the wet mixture into the melting chamber.

The present invention relates to a plant for melting a raw-material composition suitable for obtaining glass fibers of the mineral wool type for thermal or sound insulation, cullet, so-called reinforcing textile glass yarns, and/or flat glass or container glassware.

In the present text, these “raw materials” first comprise vitrifiable materials which make it possible to obtain the targeted mineral composition of the glass or rock or silicate type. These vitrifiable materials comprise silica sand, but also all the additives (sodium carbonate, limestone, dolomite, aluminum, etc.), and any type of cullet. In the description, the terms “liquid glass” and “glass melt” refer to the product of the melting of these vitrifiable materials. Also included in the raw material compositions are recyclable materials containing (organic) fuel elements such as, for example, waste of sized mineral fibers, with binder (of the type used in thermal or acoustic insulation or used in the reinforcement of plastic material), taken from the production plants of said fibers (factories), worksites (construction or deconstruction) and/or recycling streams that make it possible to recover such fibers from end products, whether or not they have been used. Such mineral fibers may in particular consist of glass and/or rock. They are then known as glass wool and rock wool, respectively. Also included are laminated glazed units with sheets of polymer of the polyvinyl butyral type such as windshields, glass bottles (household cullet), or any type of “composite” material that combines glass and plastic materials such as certain bottles. Also recyclable are “glass-metal composites or metal compounds” such as glazed units coated with enamel layers, metal layers and/or different connection elements. Also included in the raw materials are all the biomass forms, that is organic matter of plant, animal, bacterial or fungal origin, which can be used mainly as fuel, but also acting as a raw material influencing the composition of the vitrifiable material manufactured since its ash content is generally not zero.

Using materials derived from recycling streams as raw materials has undeniable advantages, such as reducing the consumption of raw materials and energy, and more generally reducing the carbon footprint of the manufacturing method as a whole.

However, these recyclable wastes have the particularity of having significant, highly variable humidity levels. In the description, moisture content is understood to mean the mass percentage of water contained in a “wet” mixture of recyclable waste, such a mixture generally consisting of mineral wool and/or biomass. Since mineral wool remains treated by users as waste, it is common that they are not stored under dry conditions. Even taking into account the hydrophobic behavior of the mineral wool, it is thus possible to expect that scraps of mineral wool stored outside uncovered contain between 20 and 70% humidity, which is not negligible.

However, field experience acquired by the inventors shows that this humidity has a doubly negative impact, which both causes a momentary drop in the temperature of the furnace and contributes to the instability of its output. Indeed, the water introduced into the combustion chamber must be discharged in the form of steam, and doing so consumes some of the heat generated by the glass bath. The evaporation of this water therefore causes a temporary and localized loss of temperature, and consequently output instability. This water is also an integral part of the overall mass of the batch composition of the raw materials fed into the furnace. At a constant feed rate, varying the moisture content therefore generates a variation in the mass of vitrifiable materials actually fed, and consequently a variation or instability of the output of the furnace. The amount of molten vitrifiable material at the furnace outlet, per unit of time (for example, in tons per day) is called output. Such variations in the momentary output of the furnace are detrimental to the quality of the glass products obtained after forming. In the particular case of the manufacture of mineral wool, these variations of output thus lead to instability in the fiberizing, which generates more waste. Another disadvantage, the quantity of fibers created at a given moment also varies, which adversely affects the density control of the products obtained. However, this is a major feature when evaluating their quality.

The invention is intended to provide a technical solution to the disadvantages described hereinbefore. More particularly, in at least one embodiment, the proposed technique relates to a method for controlling a plant for melting a raw-material composition, suitable for obtaining mineral wool, cullet, textile glass yarns and/or flat glass or container glassware, which comprises a melting chamber suitable for melting said composition, characterized in that said composition comprises at least one wet mixture of mineral wool and/or biomass, and in that said method comprises at least one step of controlling at least one physical variable that has an impact on the output of the melting chamber, said control step being carried out as a function of the moisture content of said composition and/or of said wet mixture, as measured before introduction of said composition and/or of said wet mixture into the melting chamber.

A control method according to the invention is novel and inventive in that the different physical variables which impact, that is have a direct or indirect influence on the output of the furnace, are controlled (regulated) as a function of the moisture content of said wet composition/mixture to be fed in, and not solely on the basis of a setpoint temperature to be reached within the melting chamber, as traditionally determined from complex thermodynamic models with multiple variables. And for good reason, as melting in a glass furnace has so little inertia, or in other words, such reactivity, that such a setpoint temperature is very quickly achieved, even without specific control. Conversely, any variation in the moisture content leads to an immediate response from the furnace, thus destabilizing the melting process, and its output.

A control method according to the invention therefore makes it possible to very reactively anticipate the negative effects generated by the moisture content of the composition/wet mixture on the furnace, in order to help stabilize its output and thus ultimately improve the quality of the glass products formed.

According to a particular embodiment, the wet mixing of mineral wools and/or biomass represents between 1 and 50% by weight and preferably between 10 and 40% by weight of the raw-material composition.

According to a particular embodiment, said at least one physical variable impacting the output of the melting chamber is the feed rate of said composition into the melting chamber.

As detailed in the description, when the raw-material composition is being fed into the furnace at a constant rate, varying the moisture content generates a variation in the mass of vitrifiable materials actually fed, and consequently a variation or instability of the output of the furnace. Adjusting the feed rate as a function of this moisture content therefore makes it possible to overcome this problem, in order to help stabilize the output.

According to a particular embodiment, the facility is equipped with at least one burner, preferably of the submerged type, and/or with at least one bubbler.

Submerged burners are fed with gas and air, and are generally arranged so that they are flush with the bottom of the melting chamber, so that the flame develops within the mass of raw materials being liquefied. These burners can be such that their gas supply lines are flush with the wall through which they pass. According to some embodiments, it is also possible to choose to inject only the gases resulting from combustion, the combustion being carried out outside the melting chamber itself.

Given the high reactivity of the submerged burner furnaces, and therefore the output instabilities that may result therefrom, a method according to the invention is particularly suitable for this type of furnace.

According to a particular embodiment, said composition is at least partly fed under the level of the glass bath.

Given the high reactivity of the furnaces in which the feeding is at least partly carried out beneath the level of the glass bath, or in other words, within the vitrifiable material as it is melting, and therefore the output instabilities which may result therefrom, a method according to the invention is particularly suitable for this type of furnace.

According to a particular embodiment, said at least one physical variable impacting the output of the melting chamber is the power of said at least one burner.

As detailed in the description, the discharge of the water introduced into the furnace generates a temporary and localized loss of temperature, and consequently output instability. The adjustment of the heating power of the glass bath by the burner(s), generally expressed in Kwh, as a function of this moisture content therefore makes it possible to overcome this problem ahead of time, in order to prevent and avoid the output instabilities.

According to a particular embodiment, the control method implements a plurality of burners, and said step of controlling the power is mainly implemented on the burner(s) arranged closest to a point of feeding said raw-material composition into the melting chamber.

Within the meaning of the invention, the implementation of said step of controlling the power is mainly centered on the burner(s) arranged so-called “proximal” to a point of introduction of raw materials, the ratio of the power deviation applied to the proximal burner(s) to the power deviation applied to the other burners is greater than 75%, preferably greater than 90%, preferably greater than 95%.

It has been observed by the inventors that temperature drops caused by the moisture of the fed-in composition are localized at the furnace inlet. It is therefore preferable to concentrate the power control as close as possible to this point of feeding.

According to a particular embodiment, the control method comprises at least one step of direct or indirect measurement of the moisture content of said composition and/or of said wet mixture, preferably by means of at least one radar-type sensor.

A measurement of the moisture content makes it possible to adapt in real time the targeted physical variable(s), with an output stability objective.

Empirical tests carried out by the inventors have made it possible to identify radar-type sensors as particularly suitable for measuring this moisture content. Such sensors are adapted to apply an electric field to the wet composition/mixture evaluated in order to measure its electrical permittivity and to deduce therefrom its moisture content.

According to a particular embodiment, the control method comprises at least one step of pressing said wet mixture, preferably by means of a screw press, and a subsequent step of measuring the moisture content of said pressed wet mixture, after and/or preferably before incorporating said pressed wet mixture into said raw-material composition.

The prior pressing of said wet mixture makes it possible to reduce its moisture content, and therefore the negative influence of that moisture on the melting process. The measurement of the moisture content before the wet mixture pressed into the raw-material composition is carried out on a reduced volume of material, and is therefore more reliable. The same measurement performed after incorporation makes it possible to take into account the moisture content of the whole fed-in composition. Finally, combining these two measurements makes it possible to deduce the moisture content of the composition apart from the wet mixture.

According to a particular embodiment, the control method comprises a prior step of measuring the moisture content of said wet mixture, before pressing.

The comparison of the measurements carried out before and after pressing makes it possible to evaluate the effectiveness of the pressing on the change in moisture content and, preferably, to adjust the setting of the pressing tool, generally a screw, in order to achieve and maintain a target efficiency value.

According to a particular embodiment, the vitrifiable materials are fed into the melting chamber at a rate greater than or equal to 10 tons per day, preferably greater than or equal to 25 tons per day, preferably greater than or equal to 50 tons per day, preferably greater than or equal to 100 tons per day.

According to a particular embodiment, the step of controlling the physical variable impacting the output implements a PID controller that varies this physical variable, based on said measured moisture content.

According to a particular embodiment, said measured moisture content is between 3% and 50% by mass, preferentially between 4% and 30% by mass, preferentially between 5% and 15% by mass, preferentially between 6% and 10% by mass.

The lower the moisture content of the composition and/or the wet mixture introduced into the melting chamber, the more limited the instabilities generated therein are.

The invention also relates to a computer program downloadable from a communication network and/or recorded on a recording medium suitable for being read by a computer and/or executed by a processor, comprising an instruction code for implementing the control method described above.

The invention also relates to a computer recording medium, on which such a computer program is recorded.

The invention also relates to a plant for melting a raw-material composition comprising at least a wet mixture of mineral wool and/or biomass, suitable for obtaining mineral wool, cullet, textile glass yarns and/or flat glass or container glassware, said plant comprising a melting chamber suitable for melting said composition and a control system suitable for implementing such a control method.

According to a particular embodiment, said plant is equipped with at least one burner, preferably of the submerged type, and/or of at least one bubbler and/or is suitable for feeding said raw-material composition beneath the level of the glass bath.

The invention also relates to a method for manufacturing glass or rock mineral wool, cullet, textile glass yarns and/or flat glass or container glassware, implementing such a plant.

The vitrifiable material manufactured by the method according to the invention is a mineral material, generally of the oxide type, generally comprising at least 30% by mass of silica, such as a glass or a rock or a silicate such as an alkaline and/or alkaline-earth silicate.

A glass or a rock generally comprises:
SiO2: 30 to 75% by weight,
CaO+MgO: 5 to 40% by weight,
Na2O+K2O: 0 to 20% by weight,
Al2O3: 0 to 30% by weight,
Iron oxide: 0 to 15% by weight.

If a glass is to be made, then the composition of the manufactured vitrifiable material generally comprises:
SiO2: 50 to 75% by weight,
CaO+MgO: 5 to 20% by weight,
Na2O+K2O: 12 to 20% by weight,
Al2O3: 0 to 8% by weight,
Iron oxide: 0 to 3% by weight,
B2O3: 2 to 10% by weight.

If a rock (also called “black glass” by the person skilled in the art) is to be made, the composition of the manufactured vitrifiable material generally comprises:
SiO2: 30 to 50% by weight,
CaO+MgO: 20 to 40% by weight,
Al2O3: 10 to 26% by weight,
Iron oxide: 3 to 15% by weight.

The molten vitrifiable mineral material manufactured according to the invention is extracted from the furnace in order to be solidified by cooling in an appropriate form. In particular, it can be extracted from the molten furnace in order to be directly used in a fiberizing device to form reinforcing thread or mineral wool. Thus, the vitrifiable mineral material can be extracted from the furnace and transformed into fiber in a fiberizing device. In the fiberizing application, the vitrifiable material is generally glass or rock.

The invention also relates to a line for manufacturing glass or rock mineral wool, cullet, textile glass yarns and/or flat glass comprising:
a unit for preparing a raw-material composition, and
a plant for melting this composition as described above, said furnace comprising a feeding device.

The separate and prior preparation of a mixture preformed by the unit for preparing the composition to be fed has the advantage of being able to carefully assay the different ingredients of this mixture, independently of the operation of the furnace. This preformed mixture can be stored before being introduced into the furnace when the time comes. Generally, a preformed mixture of the kind may also be more homogeneous than if the different ingredients were introduced simultaneously into a feeding device.

Further features and advantages of the invention will become apparent from the following description of particular embodiments, given merely as illustrative and non-limiting examples, and the appended figures, for which:

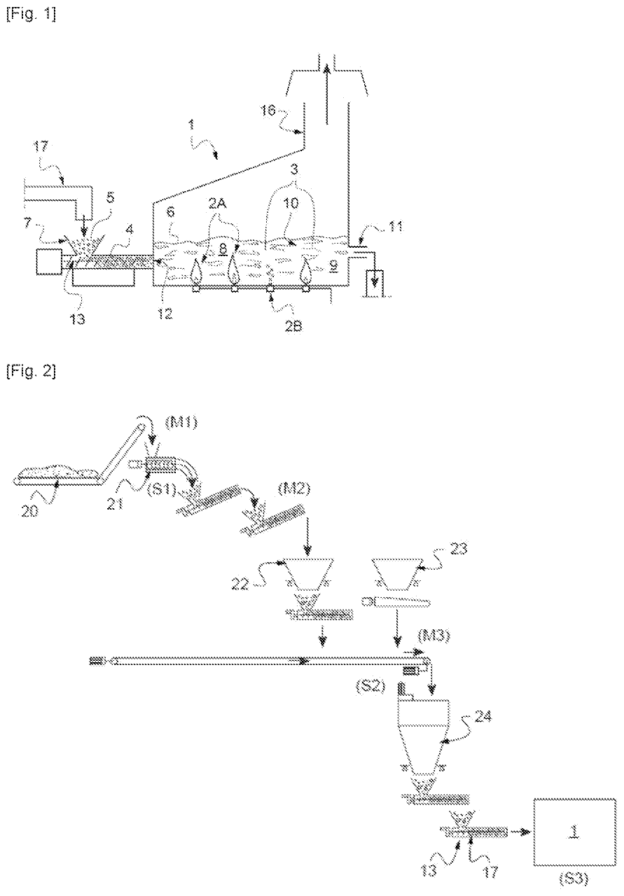

FIG. 1 is a schematic cross-sectional view of a plant for melting a raw-material composition, according to a particular embodiment of the invention,

FIG. 2 is a schematic cross-sectional view of a unit for preparing a raw-material composition to be fed in, as implemented by a manufacturing method according to the invention,

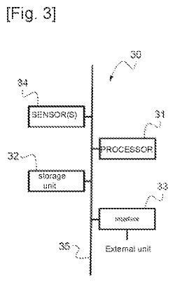

FIG. 3 is a schematic representation of a system for monitoring a plant such as that shown in FIG. 1.

The various elements illustrated in the figures are not necessarily shown to actual scale, the emphasis being more on representing the general operation of the invention. In the various figures, unless otherwise indicated, reference numbers that are identical represent similar or identical elements.

It is further understood that the present invention is in no way limited by the particular embodiments described and/or depicted, and that other embodiments are perfectly possible.

FIG. 1 schematically shows a submerged-burner furnace (plant) usable in the context of the invention, seen in cross-section from the side. A furnace 1 can be seen comprising burners 2A and a bubbler 2B immersed in a bath 3 of the vitrifiable materials being melted, at a temperature generally between 1200° C. and 1700° C. An endless screw 13 pushes a raw-material composition 5 beneath the surface 6 of the material being melted in the furnace. A dispenser 17 assays and supplies the preformed mixture to a feed hopper 7, which then supplies the endless screw 13 rotating in a casing 4. The dispenser 17 is therefore in charge of the instantaneous feeding rate. The preformed mixture is introduced into the furnace via the orifice 12, also called the point of feeding. The inside of the furnace comprises a tank 8 containing the bath 3 of melting vitrifiable material. The formed mineral material exits via the outlet 11 below the level of the molten materials. The combustion gases escape via a chimney 16.

FIG. 2 schematically shows in cross-section a unit for preparing a raw-material composition to be fed into the furnace 1 described in FIG. 1. First, the moisture content of a wet mixture 20 of mineral wool and/or biomass is measured (step M1) before the mixture is pressurized (step S1) using a screw press 21. The moisture content of the pressed wet mixture is subsequently measured again (step M2) before being transferred into a storage silo 22. The wet mixture 20 is subsequently incorporated (step S2) into the rest of the raw materials, hitherto stored in a dedicated silo 23. The moisture content of the composition thus obtained 20 is then measured (step M3) before the composition is stored in a silo 24, while waiting to be fed into the furnace 1 and melted therein (step S3).

The invention also relates to a system 30 for controlling a plant 1 such as that described in the present text. As illustrated by FIG. 3, such a control system 30 comprises a processor 31 having a function of a processing module, a storage unit 32, an interface unit 33 and at least one device 34 for measuring the moisture content, which are connected by a computer bus 35.

The processor 31 controls the furnace 1, and in particular the loading and the feeding rate of the feed screw 13, as well as the power of the burners 2A. The storage unit 32 stores at least one program to be executed by the processor 31, and various data, including the data collected by the measurement device(s) 34, the parameters used by calculations performed by the processor 31, or the intermediate data of the calculations performed by the processor 31. The processor 31 may be formed by any known or appropriate hardware or software, or by a combination of hardware and software. The storage unit 32 may be formed by any suitable storage or means for storing the program and the data in a computer-readable manner. The program causes the processor 31 to implement a control method such as that described in the present text.

The interface unit 33 provides an interface between the control system 30 and an external apparatus. The interface unit 33 may in particular be in communication with the external apparatus via a cable or a wireless communication. In this embodiment, the external apparatus can be the feed screw 13 and/or the first burner 2A. In this case, values measured by the measurement device 34 can be entered into the system 30 through the interface unit 33, then stored in the storage unit 32.

Although a single processor 31 is shown in FIG. 3, a person skilled in the art will understand that such a processor 31 can comprise different modules and units implementing the functions executed by the control system 30. These functions can also be carried out by a plurality of processors 31 communicating with each other.

1. A method for controlling a plant for melting a raw-material composition, suitable for obtaining mineral wool, cullet, textile glass yarns and/or flat glass or container glassware, which comprises a melting chamber adapted to melt said raw-material composition, wherein said raw-material composition comprises at least one wet mixture of mineral wool and/or biomass, said method comprising controlling at least one physical variable that has an impact on an output of the melting chamber, said controlling being carried out as a function of a moisture content of said raw-material composition and/or of said wet mixture, as measured before introduction of said raw-material composition and/or of said wet mixture into the melting chamber.

2. The control method according to claim 1, wherein said at least one physical variable impacting the output of the melting chamber is a feed rate of said raw-material composition into the melting chamber.

3. The control method according to claim 1, wherein the plant is equipped with at least one burner and/or of at least one bubbler.

4. The control method according to claim 1, wherein said raw-material composition is at least partly fed under a level of a glass bath.

5. The control method according to claim 3, wherein at least one physical variable impacting the output of the melting chamber is a power of said at least one burner.

6. The control method according to claim 5, wherein the plant comprises a plurality of burners and said controlling the power is mainly implemented on one or more of the plurality of burner arranged closest to a point of feeding said raw-material composition into the melting chamber.

7. The control method according to claim 1, further comprising performing a direct or indirect measurement of the moisture content of said raw-material composition and/or of said wet mixture.

8. The control method according to claim 7, further comprising pressing of said wet mixture, and a subsequent measuring of the moisture content of said pressed wet mixture, after and/or before incorporation of said wet mixture pressed into said raw-material composition.

9. The control method according to claim 8, further comprising a prior step of measuring the moisture content of said wet mixture, before pressing.

10. The control method according to claim 1, wherein vitrifiable materials are fed into the melting chamber at a rate greater than or equal to 10 tons per day.

11. The control method according to claim 1, wherein said controlling implements a PID controller that varies said physical variable impacting the output of the melting chamber, based on said measured moisture content.

12. The control method according to claim 1, wherein said moisture content is between 3% and 50% by mass.

13. (canceled)

14. A non-transitory computer recording medium, on which a computer program comprising one or more instruction codes for implementing a control method according to claim 1 is recorded.

15. A plant for melting a raw-material composition comprising at least a wet mixture of mineral wools and/or biomass, suitable for obtaining mineral wool, cullet, textile glass yarns and/or flat glass or container glassware, said plant comprising a melting chamber adapted to melt said raw-material composition and a control system adapted to implement a control method according to claim 1.

16. The plant according to claim 15, comprising at least one burner and/or with at least one bubbler and/or is the plant is adapted to feed said raw-material composition beneath a level of a glass bath.

17. A method for manufacturing glass or rock mineral wool, cullet, textile glass yarns and/or flat glass or container glassware, implementing a plant according to claim 15.

18. The control method according to claim 3, wherein the at least one burner is a submerged burner.

19. The control method according to claim 7, wherein the direct or indirect measurement of the moisture content of said raw-material composition and/or of said wet mixture is carried out by at least one radar-type sensor.

20. The control method according to claim 8, wherein the pressing of said wet mixture is carried out by a screw press.

21. The control method according to claim 10, wherein the rate is greater than or equal to 25 tons per day.
